(19) United States
(12) Patent Application Publication
(10) Pub. No.: US 2014/0055847 A1
(43) Pub. Date: Feb. 27, 2014

(54) IR REFLECTORS FOR SOLAR LIGHT MANAGEMENT

(71) Applicant: Martin Stalder, Oberwil (CH)

(72) Inventor: Martin Stalder, Oberwil (CH)

(73) Assignee: BASF, Ludwigshafen (DE)

(21) Appl. No.: 14/114,438

(22) PCT Filed: Apr. 27, 2012
(86) PCT No.: PCT/IB12/52113

§ 371 Date: Oct. 28, 2013

Related U.S. Application Data
(60) Provisional application No. 61/479,905, filed on Apr. 28, 2011.

(30) Foreign Application Priority Data
Apr. 28, 2011 (EP) 11164168.4

(51) Int. Cl. G02B 5/20; B29C 59/02; B29C 59/16; G02B 6/10

(52) U.S. Cl. CPC G02B 5/208; G02B 6/102; B29C 59/02; B29C 59/16
USPC 359/350; 385/130; 428/156; 428/161; 428/76; 264/447; 264/129; 427/532

(57) ABSTRACT

A structure (100) comprises a transparent substrate (110) having a surface (104), and the surface (104) has a three dimensional pattern (310) resulting from a combination of at least two surface waves (312, 314, 316). The at least two surface waves (312, 314, 316) differ in wavelength by in maximum 50% based on the wavelength of the wave of the at least two surface waves (312, 314, 316) having the bigger wavelength. Each wavelength of the at least two waves (312, 314, 316) is selected from the range of 200 to 900 nm. The structure (100) may be integrated into plastic films or sheets or glazings, especially for the purpose of light management.

The invention relates to the management of radiation, and more specifically to the control of the reflection behavior of structures when irradiated with electromagnetic waves, for example structures used in solar light management. Furthermore the invention is related to production processes of structures with a defined reflection behavior especially in the IR region.

From prior art, structures are known which provide filters or gratings to influence the reflection of electromagnetic waves when they are irradiated by these electromagnetic waves. The structures are used in several different applications like security devices (e.g. for banknotes, credit cards, passports, tickets and the like), heat-reflecting panes or windows and spectrally selective reflecting pigments.

In U.S. Pat. No. 4,484,797 a zero-order diffraction filter is described for use in authenticating or security devices. Illuminated even with non-polarized, polychromatic light, such devices show unique color effects upon rotation, and therefore can be clearly identified. Due to the fact that the filters are based on the resonant reflection of a leaky waveguide, they possess narrow reflection peaks. The possibility for varying the color effect is limited.

A tunable zero-order diffractive filter used as a tunable mirror in an external-cavity tunable laser for wavelength-division is described in WO 2005/064365. The filter comprises a diffraction grating, a planar waveguide, and a tunable cladding layer for the waveguide. The latter is made of a light transmissive material having a selectively variable refractive index to permit tuning of the filter.

A heat-reflecting pane is described in EP-A-1767964 as a zero-order diffractive filter with appropriate parameters to control the transmission, absorption and/or reflection of infrared and visible electromagnetic radiation. The pane is used for IR-management purposes in solar-control applications where the transmission of solar energy into a building or a vehicle has to be controlled. The functionality of the filter is reached by providing a structure with a waved surface, the waved surface providing only one wavelength.

Zero-order diffraction filters are sometimes described in the art under different names such as guided-mode resonant filter, resonant waveguide filter or resonant subwavelength grating filter.

In EP-A-1862827, a diffractive filter is used for the control of the transmission of electromagnetic radiation. The purpose is the same as in EP 1767 964; however, the structure differs as the waved surface is additionally covered by a nanostructure which narrows the reflection band of the filter.

US-2005-153464 describes a method of patterning a solid state material, such as an optical semiconductor, by transferring an image created by holographic lithography onto said material.

WO 10/102,643 discloses an optical guided-mode resonance filter based on a 2-dimensional wave-structured surface, whose wavelength differs in the 2 directions parallel to the surface, which filter is tunable by turning it around the axis perpendicular to the surface.

All mentioned filters show a well defined structure for the interaction with a certain range of electromagnetic waves. These different structures have in common that they all provide a waved surface with exact one wavelength in one direction. Sometimes this waved surface is covered by an additional structure. By providing only one wavelength in this waved structure the transmission control is limited. To reflect or adsorb electromagnetic waves in multiple wavelength regions, several filters would have to be applied successively. As each filter has a different adsorption characteristic for the whole electromagnetic spectrum, the resulting transmission is influenced not only in the desired region.

An object of the invention is to mitigate at least a part of the above mentioned drawbacks of the prior art. A further object is to provide a structure that allows the control of the transmission of electromagnetic radiation in varying wavelength regions. A process to produce such a structure is also one of the objects of the invention.

These objects are solved by the structure and the processes of producing a structure as defined in the independent claims. Preferred, advantageous or alternative features of the invention are set out in dependent claims. Furthermore the explanations concerning the structure also apply for the processes and vice versa.

In a first aspect, the present invention provides a structure comprising a transparent substrate having a surface; wherein said surface has a three dimensional pattern resulting from a combination of at least two surface waves, wherein at least two of said surface waves differ in wavelength by in maximum 50%, preferably in a range from 1 to 50%, more preferably in a range from 3 to 45% and even more preferably in a range from 5 to 40%, based on the wavelength of the wave of said at least two of said surface waves having the bigger wavelength, wherein each wavelength of said at least two waves is selected from the range of 200 to 900 nm. The combination of the at least two surface waves provides a three dimensional pattern, which results from the superposition of the at least two waves oriented in the same direction (pattern often referred to as a “beat wave”).

The structure generally can be of any form or material as far as it is transparent to at least a part of solar electromagnetic radiation; the term “transparent” particularly stands for properties as defined below for the medium. This structure comprises at least one substrate, which is preferably a dielectricum or an electrical isolator. The substrate may be of any material the person skilled in the art knows for providing such a transparent substrate. The substrate may be flexible or rigid. The substrate may comprise metal compounds selected from the group consisting of metal oxides, metal sulfides, metal nitrides and ceramics or two or more thereof. The shape of the structure may be in form of a foil or at least parts of a foil. The extension of the structure in two dimensions can lay between some millimeters and some meters to kilometers. The extension in the third direction is preferably between 10 nm and 1 mm, more preferably between 50 nm and 1 μm and most preferably between 100 nm and 500 nm. Beyond the substrate, the structure may comprise further materials, like a polymer layer or a further layer. For example, the medium may be a polymer layer. If the structure comprises at least one material beyond the substrate it is called a layered structure.

According to the invention the structure comprises a substrate having a surface, wherein said surface has a three dimensional pattern. This surface preferably extends over the two wider dimensions of the structure, whereby the three dimensional pattern is built by a variation of the surface into the third dimension of the structure. The three dimensional pattern results from a combination of at least two surface waves on the surface of the substrate. By providing these at least two waves into or onto the surface of the substrate the structure of the surface is preferably fixed. This is in contrast to dynamic waves in or on a fluid medium like a liquid or a gas or a mixture thereof where the waves alter their position in or on the medium with time. This means that the surface of the structure preferably does not deform or alter in shape on its own under normal conditions, like room temperature, normal pressure and normal humidity. The surface waves have a periodic form in its extension across the surface. As noted above, the three dimensional pattern is a fixed overlay of at least two waves, each with a defined wavelength and amplitude. At least two of said surface waves differ in wavelength by in maximum 50%, preferably in a range from 1 to 50%, more preferably in a range from 3 to 45% and even more preferably in a range from 5 to 40%, based on the wavelength of the wave of said at least two of said surface waves having the bigger wavelength.

By limiting the difference of wavelengths of the at least two waves in accordance to the present invention it can be achieved that the resulting reflection effect of an irradiated electromagnetic wave is broadened and not narrowed as described in EP 1,862,827 relating to the superposition of two waves with a multiple difference of their wavelengths. As each wavelength of said at least two waves of the structure according to the invention is selected from the range of 200 to 900 nm the two different waves can not differ more than 450 nm in its wavelengths.

The single waves may have different forms, like rectangular or sinusoidal waveforms or combinations thereof. By overlaying these at least two waves the resulting three dimensional pattern shows similarity to an interference structure of at least two surface waves. The resulting pattern of the at least two surface waves has a different shape and a new periodicity than each of the at least two singular waves.

The structure of the invention generally performs the function of a zero order diffraction filter.

By irradiation of such a structure having said three dimensional pattern, as generally done by solar radiation, a diffraction of the irradiated light is reached. Said diffraction generally leads to a diminished transmission of the light towards the structure and increased reflection. The structure of the invention especially leads to an increased reflection of the longer wavelength fraction of the light such as the IR-radiation, and thus to a reduced transmission of IR-radiation. The structure of the invention thus advantageously finds use in heat management, preferably as integrated part of a sheet or screen such as a glass screen, windshield, building window, solar cell, plastic film or plastic sheet e.g. for agriculture or packaging.

The invention thus further pertains to a method for reducing the transmission of solar light, or more especially to a method for reducing the transmission of IR radiation from the range 700 to 1200 nm, through a transparent element such as noted above. The method of the invention comprises integrating the above structure, device containing said structure, into said transparent element.

The structure according to the invention may primarily be applied in the field of energy management. For this reason the three dimensional pattern of the structure is preferably structured in a way that it reflects at least 10%, preferably at least 30%, more preferably at least 50% and even most preferably at least 70% of electromagnetic radiation in the region of 700 to 1200 nm, preferably 700 to 1100 nm and more preferably 750 to 1000 nm.

In a preferred embodiment said substrate is at least partly surrounded by a medium wherein between said substrate and said medium said surface is provided, wherein said substrate and said medium differ in refractive index and generally are in direct contact with each other. The configuration of the substrate at least partly being surrounded by a medium is called a layered structure in the sense of the invention. Such a layered structure comprises at least two different materials having different refractive indices.

The medium of said layered structure can fulfill different functions. One function can be to prevent the destruction of the surface of the substrate with the three dimensional pattern on it. Therefore the medium might surround the substrate completely or at least partly. In a preferred embodiment the medium only covers the surface providing the three dimensional pattern. This has the advantage that only two layers of material interact with the propagating electromagnetic waves. A further function of the medium could be to provoke a high difference of refractive indices between the substrate and the medium. The higher the difference between the refractive indices of two contacting materials the more an electromagnetic beam is diffracted. By this effect the reflection properties of the structure can be influenced in a desired direction.

In a preferred embodiment a structure is provided wherein said substrate has a higher refractive index than said medium. The diffraction of electromagnetic waves irradiated onto the structure results on one hand side in a reflection of a part of the electromagnetic waves at the interface of the substrate and the medium. On the other hand a part of the irradiated electromagnetic waves couples into the substrate, whereby the substrate acts as waveguide. Thus, the substrate generally may have a thickness up to several micrometer; preferred substrate thickness ranges from 20 nm to 1500 nm, especially from 50 to 1000 nm. This is especially the case when the medium has a I refractive index lower than the substrate. The choice of material of the substrate has also an influence on the waveguiding properties of the substrate. A substrate with a metal component has a better ability to guide radiation than materials without metal compounds.

In a preferred embodiment said three dimensional pattern shows a maximal amplitude in a range of up to 500 nm, preferably in a range of 50 to 400 nm, more preferably in the range of 100 to 350 nm. If the amplitude of the three dimensional pattern is higher than the thickness of the substrate, also the opposite surface of the substrate incorporates a waved pattern. This waved pattern is inverse to the opposing three dimensional pattern. It is possible that the whole substrate follows in its thickness the shape of the three dimensional pattern. The amplitude of the three dimensional pattern is also a result of the combination of the two waves. In general the amplitudes of the single waves are below or in the same range as the amplitudes of the three dimensional pattern. By combining, such as interfering at least two waves with different wavelengths but comparable amplitudes a three dimensional pattern results with waves having regions with varying amplitudes. The surface with this combination pattern might reflect a broad region of wavelengths.

The three dimensional pattern can also be considered to be a grating, for example a zero-order grating. Gratings are able to diffract incident light. Dependent on their shape it can be distinguished between one-order gratings and multi-order gratings. One order gratings are in general defined to have a three dimensional pattern with only one wavelength, also called grating period. Multi-period gratings are in general defined to have a three dimensional pattern providing more than on wavelength. A zero-order grating interacts mainly with radiation beams that hit the structure perpendicular to the substrate surface. With a zero-order grating the part of incident radiation with the highest energy load could be filtered.

The propagation behavior of the electromagnetic waves interacting with the structure is also dependent on the irradiation angle and the wavelength of the irradiated waves. The three dimensional pattern of the structure can act as a grating coupler for waves with wavelengths that correspond to the three dimensional pattern and propagate in a certain angle towards the structure. The portion of the electromagnetic waves that couple into the substrate propagate for a certain distance in the substrate and looses energy by interacting with the surfaces. Due to this energy loss, it is assumed, that the electromagnetic wave more likely couples out of the substrate in the direction where it came from. So this portion of the electromagnetic waves is additionally reflected by the structure. The portion of electromagnetic waves that couples into the substrate depends inter alia on the surface pattern of the substrate. If the three dimensional pattern has only one kind of waves with one wavelength and one amplitude, only one kind of electromagnetic wave can be reflected at, or coupled into, the structure. It has been the finding of the invention that in case there is more than one surface wave with more than one wavelength or amplitude in the substrate, more than one wavelength of the irradiation is reflected and thus can be hindered to transmit through the substrate.

Alike the substrate, the medium generally is transparent to electromagnetic waves from the significant range of solar light (general wavelength range from ca. 300 up to ca. 2500 nm), thus permitting transmission of at least 10%, preferably at least 30%, and more preferably at least 50% of solar radiation energy, especially of the visible range (400 to 800 nm). Preferably, the transparency lies in the region from 300 to 1200 nm, preferably in the region from 300 to 800 nm. For the usage in windows, such as windscreens for vehicles, for example the medium should be transparent at least in the visible region in the range from 300 to 800 nm, especially 400 to 800 nm. However materials used for windscreen, for example glass or plastics often also transmit electromagnetic waves in a broader region up to 1000 or 1200 nm. The medium might comprise or be built of any material the person skilled in the art would use to provide the before mentioned usages of the medium. The medium is preferably solid at least after contact with the substrate. Preferably the medium is able to be coupled to the substrate without destroying the three dimensional pattern. The material of the medium might be selected form the group consisting of a polymer, a glass, a metal and a ceramic or two or more thereof. In a preferred embodiment the medium comprises a polymer layer. This polymer layer preferably comprises more than 20% of weight of a polymer, more preferably more than 50% of weight and even more preferably the polymer layer is a polymer. The medium or polymer layer may have a thickness in the range of 100 nm to 1 mm, preferably in the range from 500 nm to 0.5 mm and even more preferably in the region from 800 nm to 200 μm. As described in more detail later on the medium may be provided first with a three dimensional pattern on its surface, whereby the substrate is placed on that structure to provide a layered structure.

In a preferred embodiment the medium comprises at least one thermoplastic polymer. This thermoplastic polymer preferably comprises more than 20% of weight of a thermoplastic polymer, more preferably more than 50% of weight and even more preferably the thermoplastic polymer layer is a thermoplastic polymer. The medium of the structure preferably comprises a hot embossable polymer or a UV curable resin or at least two thereof. The medium of the structure preferably comprises a polymer selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, poly vinyl chloride, polyvinylbutyral or two or more thereof.

Also the difference of the refractive index between the substrate and the medium is supposed to have an influence on the behavior of a beam of an electromagnetic wave when irradiated onto the structure. So the choice of the materials of the substrate and the medium together with the shape of the three dimensional pattern is responsible for the propagation behavior of electromagnetic waves through the structure. Preferably the structure is provided, wherein the substrate and the medium differ in their refractive index by at least 0.3, preferable at least 0.5 and even more preferable at least 0.9.

As already mentioned the transparent substrate can be composed of materials which are transparent in a broad region of the spectrum of electromagnetic waves. The structure comprises at least 20% of weight, preferably more than 40% of weight and most preferably more than 60% of weight the transparent substrate. In a preferred embodiment the substrate comprises a metal oxide or a metal sulfide or both. The substrate preferably comprises more than 20% of weight, preferably more than 50% of weight and even more preferably more than 80% of weight of a metal oxide or a metal sulfide or both. In a preferred embodiment the substrate is selected from the group consisting of TiO₂, ZnS, Ta₂O₅, ZrO₂, SnN, Si₃N₄, Al₂O₃, Nb₂O₅, HfO₂, AlN or two or more thereof.

Additionally the structure or the layered structure may comprise a further layer, for example in the form of a further polymer layer. The further layer may differ in material and properties from the medium. For example the further layer may give the structure a more rigid constitution to prevent especially the three dimensional pattern from mechanical forces.

In a further aspect the invention relates to a process to provide a way to generate a layered structure in the form as described before. The process for producing a layered structure according to the present invention comprising the steps:
i. providing a resin comprising a resin surface,
ii. forming a resin waved image on said resin surface,
iii. transforming the resin waved image onto a surface of a medium obtaining a three dimensional pattern resulting from a combination of at least two surface waves,
iv. depositing a transparent substrate on at least a part of said three dimensional pattern,
   wherein
   the resin waved image is formed by applying a first radiation beam from a first direction and a further radiation beam from a further direction differing from said first direction on said resin surface, wherein said first radiation beam and said further radiation beam form an angle θ, altering at least one direction of said first beam or said further beam towards said resin surface. The layered structure obtained by the present process preferably is the one described in the first aspect of the present invention.

The resin can be built of any material the person skilled in the art knows that can be structured at its surface by heat or mechanical processes. This can be for example a resist that is well known from the photo resist technology. Said resists are used in the field of microelectronics and micro system technology. The resist in form of a resin may be formed of a polymer, for example an acrylic polymer like polymethyl methacrylate (PMMA) or an epoxy resin or both. The step of forming a resin waved image on said resin surface can involve several further steps. A preferred process to form a resin waved image is the well known way to create holographic patterns (holographic lithography). Firstly a master surface relief structure is generated in form of a master surface pattern. This can be made by treating the resin surface with a radiation beam for example a laser or an electron beam writing process. In both cases a resist is exposed to either photons or electrons.

By illuminating at least a part of the resin surface the polymer will harden in case it was soft before or vice versa. While illuminating the resin with a first radiation beam from a first direction and a further radiation beam from a further direction, differing from said first direction, the resin waved image is formed. The first radiation beam and the further radiation beam form an angle θ and build a beam pair. The number of radiation beams is not limited. By altering at least one direction of said first beam or said further beams towards said resin surface the resin waved image can be influenced in shape. The shape of the resulting waved image is dependent on the interaction of the at least two radiation beams.

This interaction is in turn dependent on the wavelength and amplitude as well as the angle θ of the at least two radiation beams to each other. On the surface of the resin an image is built which is created by the combination of the different radiation beams applied simultaneously or successively. As each radiation beam has a defined periodicity the resulting resin waved image also has a periodicity which differs from the original periodicities if the periodicity of the at least two radiation beams are different. If two irradiation beams have the same wavelength the resulting period of the resin waved image depends on the wavelength of the exposure radiation beams and the angle θ between the radiation beams:

P=λ/2 sin θ (1)

wherein P is the period of the grating, λ is the wavelength of the radiation beams and θ is the angle between the two radiation beams.

For the production of a resin waved image with at least two combined waves generating a multi-period grating multiple exposures of the photo resist layer by the holographic techniques are advantageous. During the multiple exposures the direction of the radiation beam might be altered.

In a preferred embodiment the process is disclosed wherein said altering of at least one direction of said first beam or said further beam results in a variation of said angle θ. One possibility to vary the angle θ would be to use a second beam pair with a second exposure angle θ₂ on the resin surface. In a preferred embodiment at least four radiation beams are utilized to create the resin waved image. These four radiation beams build two pairs of radiation beams. The exposure of the radiation beams is typically performed in two steps. In a first step the exposure under the angle θ₁ of a first beam pair is established leading to a latent grating with a period P₁. After finishing or during this exposure a second exposure of the second beam pair is established under the angle θ₂ leading to a latent grating period P₂. After the development of the resin surface in a development step the two gratings will be observed in a combined manner. The surface of the resin is modulated by the four radiation beams so that the resulting grating holds a period according to the following equation:

P₁₂=2(1/P₁+1/P₂)⁻¹ (2)

wherein P₁₂ is the average grating period, P₁ is the periodicity of the first radiation beam pair, P₂ is the periodicity of the second radiation beam pair. In the same manner the resulting grating period for the combination of three and more different waves is calculated.

An alternative way to create such a combination pattern on the resin surface would be the usage of one radiation beam pair with an angle θ₁ between the radiation beams, whereby the surface of the resin can be tilted towards the radiation beam pair.

In a preferred embodiment the process is provided wherein the altering of at least one direction of said first beam or said further beam is provoked by tilting the resin surface relative to the direction of said first beam or said further beam. For the process of tilting the resin, a holder might be provided for the resin which can be tilted in any direction. Preferably also the position of the holder in the third direction can be altered. It is dependent on the shape and size of the resin whether a tilting of the resin is more practicable or the altering the position of the radiation beams. Both processes can lead to the same waved image in the resin, represented by the three dimensional pattern.

In a further preferred embodiment the process is provided, wherein said first radiation beam and said further radiation beam each have a wavelength in a range of 200 nm to 600 nm, preferably in the range of 300 to 600 nm, more preferably in the range of 420 to 600 nm. By choosing the wavelength of the radiation beams in this range, a three dimensional pattern on the structure is obtained which reflects irradiated light preferably in the IR region. The patterned structure may be used to control energy input in a room protected by said structure, especially for heat control. In a further preferred embodiment the process is provided wherein the first and further radiation beams are selected from the group consisting of laser beam and e-beam or two thereof. Whereas during the laser processing photons interact with the surface of the resin, electrons are used when an e-beam is applied. An example for a laser is a HeCd laser. Electron beam processing involves irradiation (treatment) of products using a high-energy electron beam accelerator. Electron-beams are streams of electrons observed in vacuum. For the application of an e-beam it is referred to the article by Bly, J. H.; Electron Beam Processing. Yardley, Pa.: International Information Associates, 1988.

In a further preferred embodiment the process is provided, wherein the wavelength of said first radiation beam differ from the wavelength of said further radiation beam. As the wavelength of the radiation beams has an impact on the built surface structure of the resin, the planned structuring of the resin can be established by choosing the adequate wavelengths and especially by choosing different wavelengths of the radiation beams.

After the radiation of the resin a development step of the resist can be established which fixes the shape of the resin waved surface. During the development step the hardened or softened parts of the resin may be separated from softened or hardened polymer structures by for example solvents. The result of this development step may be a continuous surface relief structure, holding, for example, a sinusoidal cross section or a cross section of a combination of several sinusoidal and/or rectangular waves. Resists that are exposed to electron beams typically result in binary surface structures, typical for a rectangular wave form. Continuous and binary surface relief structures result in very similar optical behaviors. By a galvanic step the typically soft resist material is converted into a hard and robust metal surface, for example into a Nickel shim. This metal surface may be employed as an embossing tool. With this embossing tool providing the master surface, a medium in form of a polymer layer or foil can be embossed. The medium with the embossed three dimensional pattern serves as base for the deposition of the substrate of the layered structure. This deposition step might be established by different processes, for example vacuum vapor deposition, sputtering, printing, casting or stamping or a combination of at least two of theses processes. Preferably the substrate is deposited by vacuum vapor deposition because this process has a high accuracy concerning the thickness of the deposited materials.

Additionally a further material may be deposited onto the substrate and/or the medium. This might be a polymer layer that protects the structure against mechanical stress.

For complex structures, surface reliefs can easier be written using an electron beam writer. The electron beam size and the binary property may be concluded in suitable simulation and optimization calculations.

In a further aspect of the invention a process is provided for producing a structure comprising the steps:
i. providing a medium comprising a surface,
ii. transforming at least a portion of said surface into a three dimensional pattern resulting from a combination of at least two surface waves,
iii. depositing a transparent substrate on at least a part of said three dimensional pattern,
   wherein at least two of said surface waves differ in wavelength by in maximum 50%, preferably in a range from 1 to 50%, more preferably in a range from 3 to 45% and more preferably in a range from 5 to 40% based on the wavelength of the wave of said at least two of said surface waves having the bigger wavelength, wherein each wavelength of said at least two surface waves is selected from the range of 200 to 900 nm. The structure obtained by the present process preferably is the one described in the first aspect of the present invention.

The process involves the step of providing a medium comprising a surface. The medium may be of any material mentioned for the structure above. The medium may be provided in form of a planar structure like a foil or layer or only parts thereof. The shape and dimension of the medium might be chosen as described for the structure before. The advantageously planar structure may be flexible or rigid depending on the material it consists of. On one of the surfaces of the structure a three dimensional pattern is deposited in form of a transforming step. By depositing a transparent substrate on at least a part of the three dimensional pattern the surface waves build an interface between the two materials. In a preferred embodiment the process is provided, wherein the transforming step is selected from the group consisting of embossing, stamping and printing. These processes are well known to the person skilled in the art.

In a preferred embodiment the process is provided, wherein said three dimensional pattern shows a maximal amplitude in a range of up to 500 nm, preferably in a range of 50 to 400 nm, more preferably in the range of 100 to 350 nm. By choosing the amplitude in the same range as the thickness of the substrate, a three dimensional pattern is provided that expands across the whole thickness of the substrate. The advantage of such a small layer of substrate is a high transparency in the visible region of the irradiated beam propagated through the substrate.

In a further preferred embodiment the process is provided, wherein the medium comprises a polymer layer. The polymer layer may have a thickness in the range of 100 nm to 1 mm, preferably in the range from 500 nm to 0.5 mm and even more preferably in the region from 800 nm to 200 μm. In a further preferred embodiment the process is provided, wherein the polymer layer comprises at least one thermoplastic polymer.

In a further preferred embodiment the process is provided, wherein the medium comprises a polymer selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, polyvinyl chloride, polyvinylbutyral or two or more thereof. The medium also may comprise other material, preferably any kind of hot embossable polymers or UV curable resins or at least two thereof.

In a further preferred embodiment the process is provided, wherein the substrate and the medium differ in their refractive index by at least 0.3, preferably at least 0.5 and even more preferably at least 0.9.

In a further preferred embodiment the process is provided, wherein the substrate comprises a metal oxide or metal sulfide. In a further preferred embodiment the process is provided, wherein the substrate is selected from the group consisting of TiO₂, ZnS, Ta₂O₅, ZrO₂, SnN, Si₃N₄, Al₂O₃, Nb₂O₅, HfO₂, AlN or two or more thereof.

In a further aspect of the invention a structure is provided obtainable from a process according to any of the described processes.

In a further preferred embodiment the structure is provided, wherein said structure comprises at least a further layer. The further layer can be of any material that is known to the person skilled in the art to provide a layered structure which is transparent to at least a part of the solar electromagnetic wave spectrum as noted above. The further layer may comprise the same material as the medium. In a preferred embodiment said further layer comprises at least 50 wt. %, preferably at least 70 wt. %, more preferably at least 90 wt. % of a polymer. The polymer might be selected from the materials cited before. The further layer may also be called a lamination or encapsulation layer. Preferably the further layer comprises a polymer selected from the group consisting of hot embossable polymer, polymethyl methacrylate, polyethylene terephthalate, polyethylene, polycarbonate, polyetherimide, polyetherketone, polyethylene naphthalate, polyimide, polystyrene, poly-oxy-methylene, polypropylene, poly vinyl chloride, polyvinylbutyral and including ultraviolet curable resins.

In a further preferred embodiment the structure is provided, wherein said structure is selected from the group of pigments, glass screens like windshields, building windows, solar cells or photovoltaic cells. The material of the structure can be any of those described before. The structure may be provided in different shapes for these different objects and uses. In the case of pigments the structure may be formed in small particles. The size of these particles may vary between 1 μm to several millimeters. In the case of glass screens the shape of the structure may be in the form of a foil with a much larger extension in two dimensions than in the third dimension. The foil may have a thickness ranging from 1 nm to several millimeters, a lengths and widths of several millimeters to several meters. The structure used for solar cells or photovoltaic cells may be in the same region as the foil described for glass or window applications, however the width and length are in general smaller, in the range of several μm to several centimeters. In a further aspect of the invention a use of the before described structure is provided in pigments, glass screens like windshields, architectural structures like windows, in solar cells or photovoltaic cells. For these uses, the structure may be combined with further materials like inks, glass or plastics in differing shapes and sizes. To contact the structure with these objects, various combining steps may be applied as well known by the person skilled in the art for these purposes. Examples are covering, gluing or depositing.

The afore mentioned structures all have in common that they are preferably suitable to reflect at least a part of a radiation in the region of 700 nm to 1000 nm. Preferably the structure is mainly transparent in the visible region. The usage of said structure can be manifold as already mentioned. The structure according to the invention may primarily be applied in the field of energy management. For this reason the three dimensional pattern of the structure is preferably structured in a way that it reflects at least 10%, preferably at least 30%, more preferably at least 50% and even most preferably at least 70% of electromagnetic radiation in the region of 700 to 1200 nm, preferably 700 to 1100 nm and more preferably 750 to 1000 nm.

Thus, the invention includes the following subjects:

[1] A structure (10, 100) comprising a transparent substrate (110) having a surface (112); wherein said surface (112) has a three dimensional pattern (310) resulting from a combination of at least two surface waves (312, 314, 316), wherein at least two of said surface waves (312, 314, 316) differ in wavelength by in maximum 50% based on the wavelength of the wave of said at least two of said surface waves (312, 314, 316) having the bigger wavelength, wherein each wavelength of said at least two waves (312, 314, 316) is selected from the range of 200 to 900 nm.
[2] The structure [1], wherein said substrate is at least partly surrounded by a medium (102); wherein between said substrate (110) and said medium (102) said surface (112) is provided; wherein said substrate (110) and said medium (102) differ in refractive index.
[3] One of the above structures, wherein said substrate (110) has a higher refractive index than said medium (102).
[4] One of the above structures, wherein said three dimensional pattern (310) shows a maximal amplitude in a range of up to 500 nm.
[5] One of the above structures, wherein said medium (102) comprises a polymer layer (102).
[6] A structure as under [5] above, wherein said medium (102) comprises at least one thermoplastic polymer.
[7] One of the above structures, wherein said medium (102) comprises a polymer selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, poly vinyl chloride, polyvinylbutyral or two or more thereof.
[8] One of the above structures, wherein said substrate (110) and said medium (102) differ in their refractive index by at least 0.3.
[9] One of the above structures, wherein said substrate (110) comprises a metal oxide or a metal sulfide or both.
[10] A structure as under [9] above, wherein said substrate (110) is selected from the group consisting of TiO₂, ZnS, Ta₂O₅, ZrO₂, SnN, Si₃N₄, Al₂O₃, Nb₂O₅, HfO₂, AlN or two or more thereof.
[11] A Process for producing a layered structure (100) comprising the steps:
i. providing a resin (202) comprising a resin surface (204),
ii. forming a resin waved image (214) on said resin surface (204),
iii. transforming said resin waved image (214) on a surface (104) of a medium (102) obtaining a three dimensional pattern (310) resulting from a combination of at least two surface waves (312, 314, 316),
iv. depositing a transparent substrate (110) on at least a part of said three dimensional pattern (310),
   wherein said resin waved image (214) is formed by applying
   a first radiation beam (206) from a first direction and a further radiation beam (208, 302, 304) from a further direction differing from said first direction on said resin surface (204),
   wherein said first radiation beam (206) and said further radiation beam (208, 302, 304) form an angle θ (212, 300),
   altering at least one direction of said first beam (206) or said further beam (208, 302, 304) towards said resin surface (204).
   [12] The process according to subject [11], wherein said altering of at least one direction of said first beam (206) or said further beam (208, 302, 304) results in a variation of said angle θ (212, 300).
   [13] The process according to any of subjects [11] or [12], wherein said altering of at least one direction of said first beam (206) or said further beam (208, 302, 304) is provoked by tilting said resin surface (204) relative to the direction of said first beam (206) or said further beam (208, 302, 304).
   [14] The process according to any of subjects [11] to [13], wherein said first radiation beam (206, 210) and said further radiation beam (208, 302, 304) each have a wavelength in a range of 200 nm to 600 nm.
   [15] The process according to any of subjects [11] to [14], wherein said first and further radiation beams (206, 208, 302, 304) are selected from the group consisting of laser beam and e-beam or two thereof.
   [16] The process according to any of subjects [11] to [15], wherein the wavelength of said first radiation beam (206, 210) differ from the wavelength of said further radiation beam (208, 302, 304).
   [17] A Process for producing a structure (100) comprising the steps:
i. providing a medium (102) comprising a surface (104),
ii. transforming at least a portion of said surface (104) into a three dimensional pattern (310) resulting from a combination of at least two surface waves (312, 314, 316),
iii. depositing a transparent substrate (110) on at least a part of said three dimensional pattern (310)
   wherein at least two of said surface waves (312, 314, 316) differ in wavelength by in maximum 50% based on the wavelength of the wave of said at least two of said surface waves (312, 314, 316) having the bigger wavelength, wherein each wavelength of said at least two surface waves (312, 314, 316) is selected from the range of 200 to 900 nm.
   [18] The process according to any of the subjects [11] to [17], wherein said transforming step is selected from the group consisting of embossing, stamping and printing.
   [19] The process according to any of subjects [11] to [18], wherein said three dimensional pattern (310) shows a maximal amplitude in a range of up to 500 nm.
   [20] The process according to any of subjects [11] to [19], wherein said medium (102) comprises a polymer layer (102).
   [21] The process according to any of subjects [11] to [20], wherein said polymer layer (102) comprises at least one thermoplastic polymer.
   [22] The process according to any of subjects [11] to [21], wherein said medium (102) comprises a polymer selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, polyvinyl chloride, polyvinylbutyral or two or more thereof.
   [23] The process according to any of subjects [11] to [22], wherein said substrate (110) and said medium (102) differ in their refractive index by at least 0.3.
   [24] The process according to any of subjects [11] to [23], wherein said substrate (110) comprises a metal oxide or metal sulfide.
   [25] The process according to any of subjects [11] to [24], wherein said substrate (110) is selected from the group consisting of TiO₂, ZnS, Ta₂O₅, ZrO₂, SnN, Si₃N₄, Al₂O₃, Nb₂O₅, HfO₂, AlN or two or more thereof.
   [26] A structure (100) obtainable from a process according to any of the subjects [11] to [25].
   [27] The structure (10, 100) according to any one of subjects [1] to [10] or [26], wherein said structure comprises at least a further layer (114).
   [28] A structure (10, 100) according to any of the subjects [1] to [10] or [26] or [27], wherein said structure is selected form the group of glass screens like windshields, building windows or solar cells.
   [29] Use of the structure (10, 100) according to any of the subjects [1] to [10] or [26] to [28] in glass screens like windshields, building windows or solar cells.
   [30] Use of the structure (10, 100) according to any of the subjects [1] to [10] or [26] to [28], or a device containing said structure, such as a polymer film or plastic screen or plate or glass screen, as a reflector for solar radiation, especially IR radiation.
   [31] Use of the structure (10, 100) according to any of the subjects [1] to [10] or [26] to [28], or a device containing said structure, such as a polymer film or plastic screen or plate or glass screen, for heat management, especially in vehicles or buildings or technical devices such as solar cells.
   [32] Device containing a structure (10, 100) according to any of the above subjects [1] to [10] or [26] to [28].
   [33] Device as of subject [32] selected from polymer films, plastic screens, plastic sheets, plastic plates, and glass screens, especially for heat management.
   [34] Device as of subject [33], which comprises 3 or more layers.

The above and other features and advantages of the invention will be apparent from the following description, by way of example, of embodiments of the invention with reference to the accompanying drawings.

### DESCRIPTION OF FIGURES

FIG. 1a): scheme of a classical subwavelength grating based reflector;

FIG. 1b): reflection/transmission by a state-of-the-art resonant grating holding 1 grating period

FIG. 2: scheme of a typical arrangement of two radiation sources and a polymer resist;

FIG. 3: scheme of a plurality of radiation sources in combination with a polymer resin;

FIG. 4a): scheme of a rotating arrangement of radiation source and polymer resin;

FIG. 4b): scheme of the production process of a multi period grating with a transforming procedure of a resist waved image to a medium waved image;

FIG. 5 a-c): scheme of reflectors based on a high index coated subwavelength structure, holding, a) a single period grating, b) a two-period grating and c) a three-period grating;

FIG. 6: cross sectional view of Scanning Electron Microscope (SEM) image of a surface profile holding a 2-period grating;

FIG. 7: top view on a profile holding a 2-period grating;

FIG. 8: schematic view of a transmission spectrum of a device holding a two period grating;

FIG. 9: top view on a profile holding a 3-period grating;

FIG. 10 a-c): scheme of a binary grating pattern in one dimension;

FIGS. 11a) and 11b): scheme of a binary grating pattern in two dimensions;

FIG. 12 a): scheme of a sinusoidal wave (prior art);

FIG. 12 b): View of a Fourier transformation of the wave of FIG. 12 a);

FIG. 13 a): scheme of a rectangular wave (prior art);

FIG. 13 b): View of a Fourier transformation of the wave of FIG. 13 a);

FIG. 14 a): scheme of a rectangular wave superposed by a sinusoidal wave (prior art);

FIG. 14 b): View of a Fourier transformation of the wave of FIG. 14 a);

FIG. 15 a): scheme of two combined sinusoidal waves;

FIG. 15 b): View of a Fourier transformation of the sinusoidal wave of FIG. 15 a);

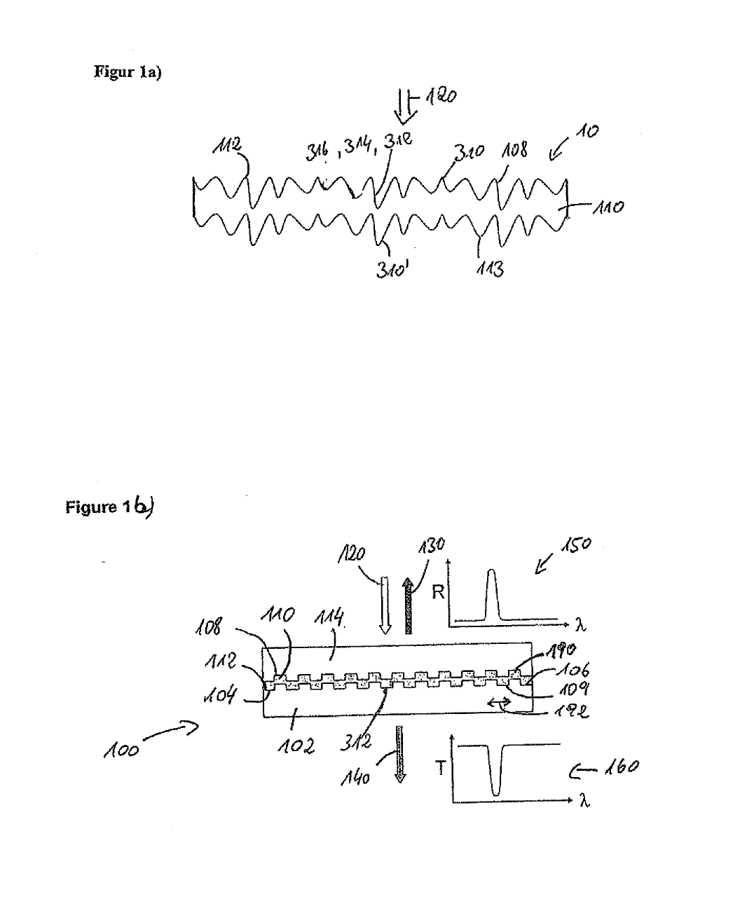

FIG. 1a) shows a structure 10 with a transparent substrate 110. The transparent substrate 110 has a surface 112 also called the substrate surface 112. The surface 112 shows a three dimensional pattern 310 resulting from a combination of at least two surface waves 312, 314, 316. Opposite to the surface 112 the substrate has another surface 113 with an inverse three dimensional pattern 310. The surface 112 of the structure 10 builds a first interface 108 where the incident irradiation beam 120 will interact with the surface waves 312, 314 and 316. Dependent on the wavelength of the irradiation beam 120 and the angle of the irradiation beam 120 towards the surface 112 of the substrate 110 the irradiation beam 120 will be reflected by the structure 10, coupled into the substrate 110 or transmitted through the structure 10. In the case the irradiation beam 120 couples into the substrate 110, the structure 10 can be called an optical diffraction grating. Said structure 10 may be the fundament of a layered structure 100 as shown in FIG. 1b).

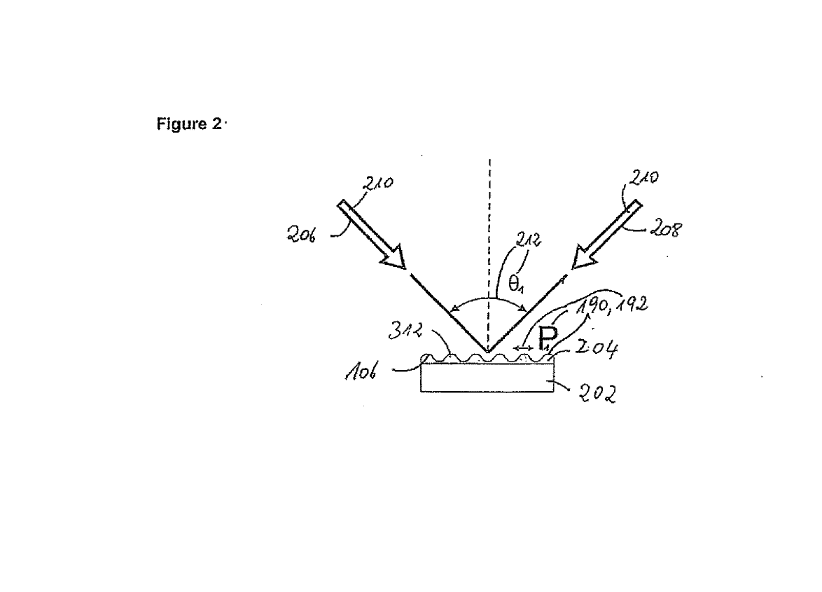

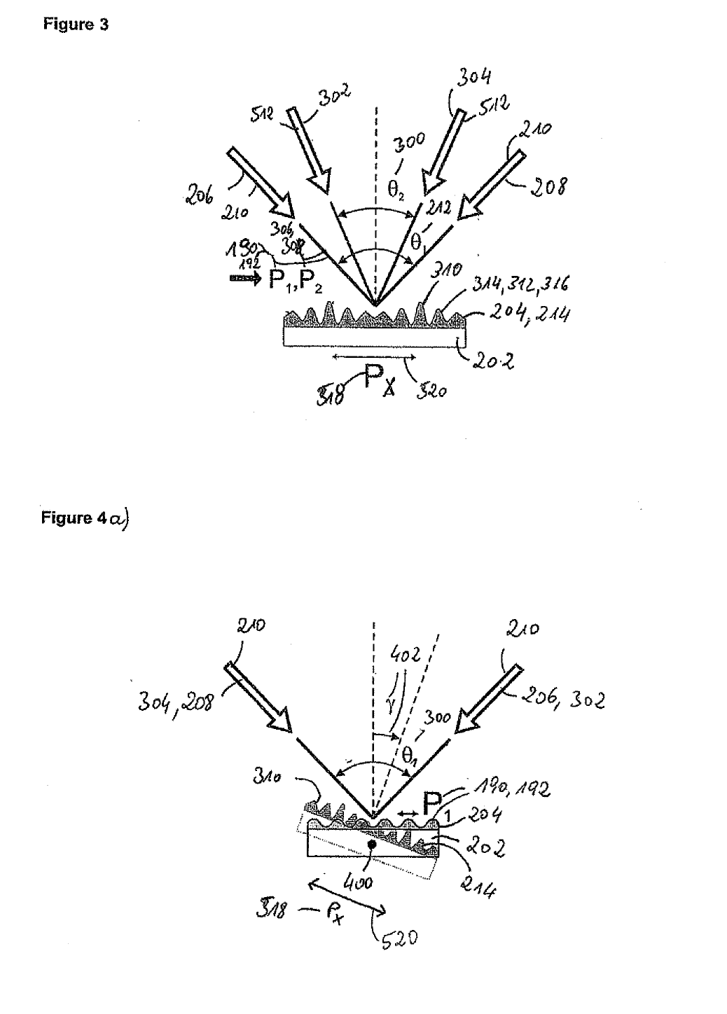

In FIG. 1b) a typical subwavelength grating in form of a layered structure 100 is shown, built of a medium 102 in form of a polymer layer 102 with a polymer surface 104. Examples of the material of the polymer layer 102 are polyethylene or polymethylmethacrylate or other polymers or mixtures thereof. A medium waved image 106 has been built on the polymer surface 104 for example by a process shown in FIG. 2. The medium waved image 106 builds an second interface 109 to a transparent substrate 110 via its substrate surface 112. Thus, the two surfaces 104 and 112 are connected to each other by the medium waved image 106 via the second interface 109. Examples of the material for the substrate 110 are TiO₂, ZnS or Ta₂O₅ or mixtures thereof. The arrows 120, 130 and 140 represent an irradiation beam 120, a reflection beam 130 and a transmission beam 140, illustrating the situation when the structure 100 is irradiated from one side. The reflection beam 130 and the transmission beam 140 result from interaction of the irradiation beam 120 with the medium waved image 106 of the layered structure 100. The reflection spectrum 150 and the transmission spectrum 160 are characteristic for a one period subwavelength grating as shown in FIG. 1b). The characteristic of these spectra 150 and 160 is that only one wavelength of the irradiation beam 120 corresponding to the grating period 190 of the waved image 190 interacts with the structure of the waved image 106 in a way that it is reflected. The substrate 110 and the polymer layer 102 are both transparent in a wide range of radiation. Thus the reflected radiation results from the interaction of the radiation with the waved image 106 at the second interface 109 where the surfaces 104 and 112 with different refractive indices are connected. In such a one period grating only radiation beams in a certain wavelength region are reflected by the waved image 106, because the waved image 106 comprises only one wave 312 with one periodically repeated waveform. This first wave 312 may be of a rectangular or a sinusoidal form or a combination thereof. The characteristic of this waveform in a one period grating is that the wavelength and the amplitude of the waved image 106 is the same for the whole layered structure 100. Such a layered structure 100 may also comprise a further layer 114 on the substrate 110. This layer 114 can prevent the destruction of the layered structure 100 by dirt or mechanical exposure. Such a layered structure 100 can also be built with waved images 106 comprising three dimensional patterns 310 as shown in FIGS. 3, 4 and 5. The architecture of the layered structure 100 shown in FIG. 1b) is exemplary for all one, two, three to n-period gratings in the way the layers are oriented as discussed for the further figures.

The medium waved image 106 can be construed by embossing a master surface pattern of a resin waved image 214, also called resist waved image 214, onto the surface 104 of the medium 102. The resin waved image 214 can be constructed by classical holographic methods or by electron beam writing. A principle way is to irradiate a surface 204 of a resin 202, as for example a resist 202 as illustrated in FIG. 2. Either with laser or with electron beam a resist 202 is exposed to either photons of, for example a laser, or of electrons of an electron beam. FIG. 2 shows an example how a waved image 106 can be generated on a resist surface 204 of a resist 202. This resist surface 204 is treated by two laser beams 206 and 208 with a certain wavelength λ₁ 210. The structure of the waved image 106 is resulting form this treatment of the resist surface 204 with the lasers 206 and 208. The resulting shape of the waved image 106 is dependent on the wavelength λ 210 and the angle θ₁ 212 between the first laser beam 206 and the second laser beam 208 on the resist surface 204. The resulting waved image 106 hosts a grating period P₁ 190 with a characteristic grating period length 192. In the example of FIG. 2, the resist waved image 214 shows only one first wave 312 as only one pair of lasers 206 and 208 with the same wavelength is applied to the resist surface 204.

As it is an objective of the present invention to form a three dimensional pattern 310 with more than one wave, the resist 202 has to be treated in a way other than shown in FIG. 2.

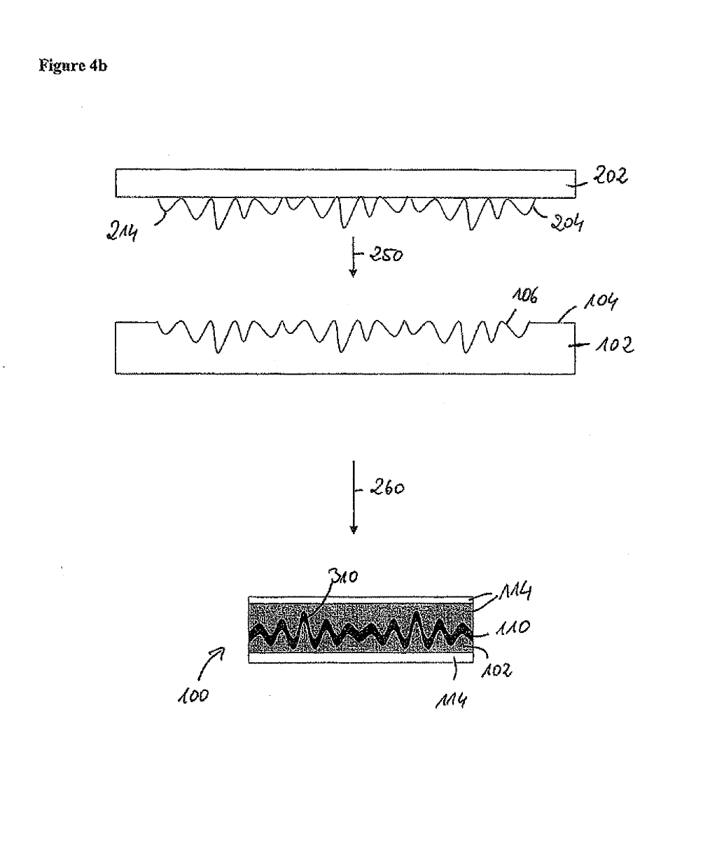

One way is shown in FIG. 3 and a further way is shown in FIG. 4a). In FIG. 3 more than two laser beams 206 and 208 are applied to the resist surface 204. These are laser beams 302 and 304. The wavelength of these laser beams 302 and 304 may vary among each other and may vary from the first laser beam 206 and/or the second laser beam 208 or may be of the same wavelength. As already mentioned the wavelength of the beams 206, 208, 302, 304 lay in the range of 300 to 1600 nm. For the shown examples the wavelength lays in the range of 400 to 500 nm. To create a regularly patterned waved image 106 it is useful to apply two pairs of laser beams to the resist surface 204. As an example the first laser beam 206 and the second laser beam 208 build a laser pair and may hold wavelength λ₁ 210 and angle θ₁ 212 between each other whereas third laser beam 302 and fourth laser beam 304 as second laser pair holds wavelength λ₂ 510 and angle θ₂ 300 between each other. The wavelength λ₁ 210 may differ from wavelength λ₂ 510 or not. By choosing a first angle θ₁ 212 between the laser beam pair 206 and 208 and a differing angle θ₁ 300 of the second laser beam pair 302, 304 a waved image 106 is formed that comprises at least two grating periods P₁ 306 and P₂ 308 each with a repeating three dimensional pattern 310. Said pattern 310 comprises two waves 312 and 314 each differing in amplitude or wavelength 318, 320 or both. Preferably the laser beam pairs 206, 208 and 302, 304 are applied one after the other to prevent the resist 202 to melt. It is also possible to apply the first pair of beams 206, 208 with the same wavelength, but under a different angle θ to the resist.

An alternative way to create a three dimensional pattern 310 is to use only one pair of laser beams 206 and 208 or 302 and 304. The laser beams 206 and 208 or 302 and 304 may be rotated vis-à-vis the resist surface 204. That can be realized by rotating or tilting the laser beams 206 and 208 or 302 and 304 or the resist 202 with its resist surface 204 by an angle γ 402. The resist 202 can for example be tilted by a tilting device 400.

The procedure of applying the laser beams 206, 208, 302, 304 in the desired angled way towards the resist surface 204 can be calculated by programs known in the prior art for the purpose of forming a hologram.

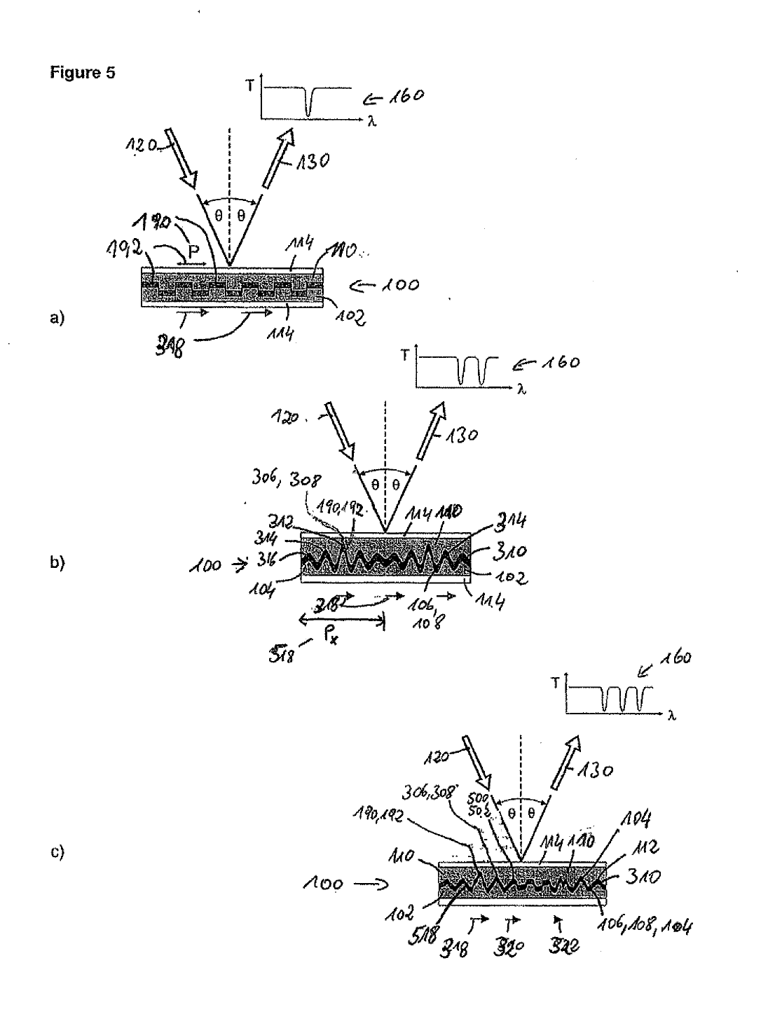

The resist surface 204 of the resist 202 with the resist waved image 214 may be used to be transformed on a surface 104 of a medium 102 for example in the form of a polymer layer 102 to build a medium waved image 106 as shown in FIG. 4b). This transformation of the waved image 214 to the medium 102 is called a transforming step or transforming process 250. This transforming process 250 may be achieved by embossing or stamping a resist waved image 214 of a resist 202 as achieved by the procedure as described above on the polymer surface 104. To enhance the transforming process the polymer surface 104 may be heat treated before the transforming step 250. Afterwards a transparent substrate 110 is deposited at least on the waved image 106 illustrated as part of a coating step 260 of FIG. 4b). Optionally a further layer 114 can be coated over the whole layered structure 100 or only on one side of the layered structure during the coating step 260. To achieve the desired result, namely to reflect a specific range of wavelength of an irradiation beam 120 by the waved image 106 of the layered structure 100, the refractive indices of the polymer layer 102 and the substrate 110 should differ from each other. This difference of refractive index should preferably be at least 0.5, preferable at least 0.7 and even more preferable at least 0.9. The described process results in a layered structure 100 as illustrated in FIGS. 1 and 5 a-c).

The described procedure for forming a resist waved image 214 can be applied multiple times on the same resist surface 204 to obtain a three dimensional pattern 310. So different laser beams 206, 208, 302, 304 may be applied in at least one or several steps to create different grating periods (190, 306, 500) with different lengths of grating periods (192, 308, 502). So a first grating period P₁ 190, a second grating period P₂ 306 and optionally a third grating period P₃ 500 and further grating periods alone or in combination may be applied to the resist surface 204. By applying more than one grating period 190, 306, 500 to the resist surface 204 a resulting resist waved image 214 in form of a three dimensional pattern 310 is achieved. This resist image 214 is then transformed to a polymer surface 104 of a polymer layer 102 with a resulting grating period Pₓ 518 and a resulting period length of Pₓ 520 as shown in FIGS. 5 b) and 5 c). FIGS. 5 a-c) show each a layered structure 100 with different types of waved images 106 on the polymer surface 104. In FIG. 5 b) two grating periods P₁ 306 and grating period P₂ 308 have been applied resulting at the three dimensional pattern 310 as shown in 5b). This three dimensional pattern 310 shows a waved image 106 with three types of waves (312, 314, 316). The first wave 312 has a greater amplitude than the second wave 314. The second wave 314 has in turn a greater amplitude than the third wave 316. The wavelength λ₁ 318 of the first wave 312 differs from the wavelength λ₂ 320 of the second wave 314 and also differs from the wavelength λ3 322 of the third wave 316. In FIG. 5 c) an example of a three-period grating with a resulting grating period Pₓ is shown resulting from three different grating periods applied to the resist surface 204. The three different grating periods 190, 306, 500 have been applied by choosing three different angles θ or wavelength λ or both for the laser beams 206, 208, 302 and 304. In this resulting grating period Pₓ the amplitude of the first wave 312, second wave 314 and third wave 316 are differing from each other. Also the wavelength λ₁ 318, wavelength λ₂ 320 and wavelength λ₃ 322 are different from each other. Depending on how many different grating periods are applied to the resist surface 204 the resulting medium waved image 106 is able to reflect one, two or more wavelength regions of an irradiated beam 120. The resulting transmission spectrum 160 for the one period grating of FIG. 5 a) shows only one reflected wavelength, whereas the transmission spectrum 160 of the two period grating of FIG. 5 b) shows two reflected wavelengths. In consequence the three period grating of FIG. 5 c) shows three reflected wavelengths in the spectrum 160 corresponding to the grating period of the waved image 106.

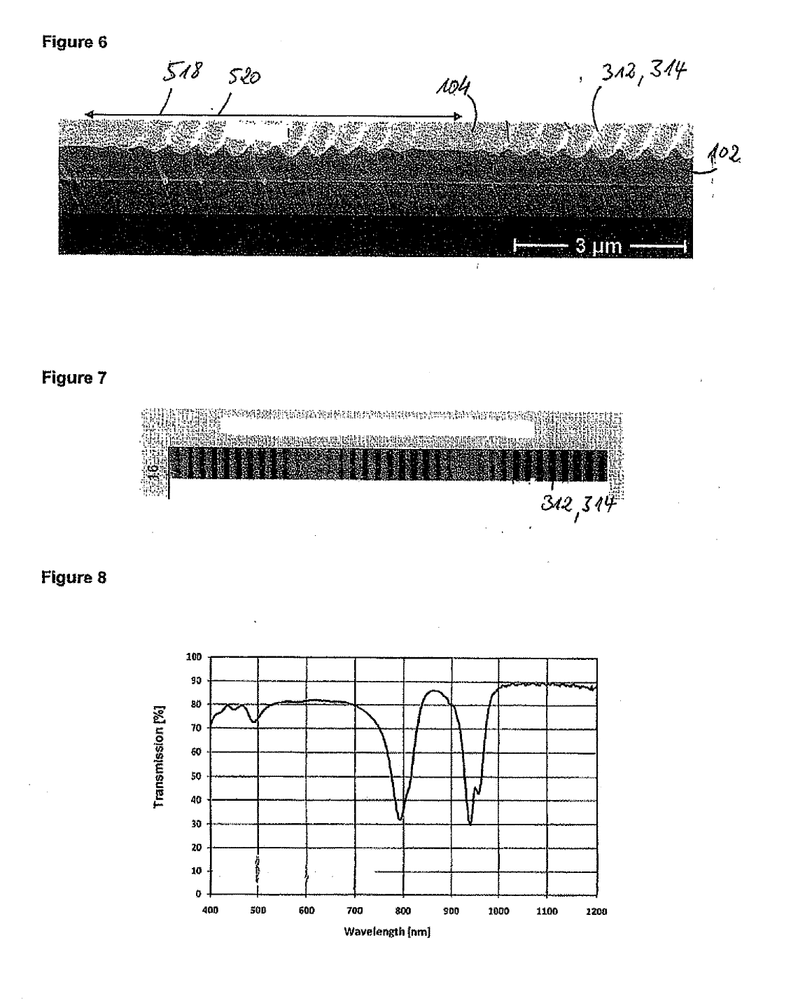

FIG. 6 shows a Scanning Electron Microscope (SEM) image created by an Atomic Force Spectrometer (AFS) of a surface profile holding a two period grating. This 2-period grating results of a combination of a 450 nm and a 488 nm grating. The resulting grating period Pₓ 518 has a period length Pₓ 520 of about 6.4 μm in half as illustrated with an arrow 600 in FIG. 6. On the surface 104 two combined waves 312, 314 are visible. For this example of a two period grating a glass wafer of 1 mm thickness and 5 inch diameter has been coated with Shipley photo resist S1805. The blue light source used for the exposure of the photo resist has been a HeCd laser with a wavelength of 442 nm. The laser exposure has been operated according to the configuration shown in FIG. 3, with four laser beams 206, 208, 302, 304 with two successive exposures at two different angles, angle θ₁ 212 and angle θ₂ 300. The exposure angles, angle θ₁ 212 and angle θ₂ 300, have been adjusted such that a grating period P₁ 190 of 450 nm and a second grating period P₂ 306 of 488 nm results. After the development of the laser exposed photo resist a surface profile and amplitude modulated surface grating Pₓ 518 of 468 nm and a length of the grating period 520 of 11.5 μm results in form of a resist waved image 214.

In a further step the surface profile 204 of the photo resist 202 has been replicated into a transparent ultraviolet crosslinker resin 102, 104. For that purpose the Ormocor Ormocomp from micro resist technology GmbH has been utilized. The Ormocomp replica was prepared on a 1 mm glass. Afterwards the high index of refraction material ZnS was coated on the resin surface 102 with a Balzers BAE 250 machine. In the shown example of FIG. 6 a ZnS film of a thickness of 110 nm has been coated on the patterned Ormocomp surface. Finally the structure 100 was encapsulated with another piece of glass and Ormocomp as a sealing glue.

A top view of the grating shown in FIG. 6 is shown in FIG. 7. The darker areas are troughs of the waves 312, 314 whereas the brighter areas are peaks of the waves 312, 314. The lengths of the two grating periods 190 and 306 are 192 P₁=450 nm, 308 P₂=488 nm.

In FIG. 8 the transmission spectrum of a structure 100 holding a two period grating is shown. The characterization has been established by a photospectrometer Lamda 9 from Perkin Elmer. The two period grating results in a double peak transmission spectrum when irradiated with radiation from a white light radiation source. The measurements were established by using a polarizer and the polarization was adjusted parallel to the extension of the lines of the grating period. Two pronounced peaks around 800 nm and 950 nm can be seen. The surface structure is based on the combination of a 450 nm and a 550 nm grating period and a 110 nm ZnS coating as substrate processed in the manner described for FIG. 6.

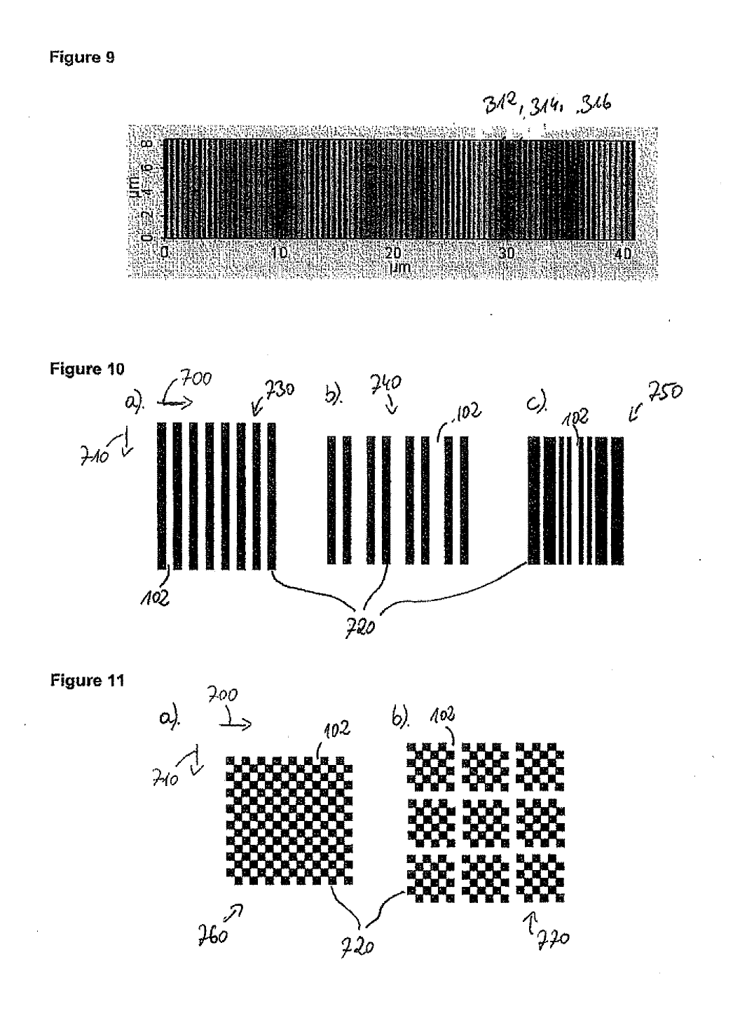

FIG. 9 is a top view of a three period grating with the initial grating periods of P₁ at 453 nm, P₂ at 474 nm and P₃ at 490 nm. For this grating the same materials and the same conditions have been applied as for the structure in FIG. 6.

It is possible to safe the information of the grating structures as a binary grating pattern 720 as shown in FIGS. 10 and 11 on a polymer layer 102, 114. In FIG. 10 this binary grating pattern 720 has only grating information in one first dimension 700 whereas the grating pattern 720 of the grating in FIG. 11 has grating information in two dimensions 700 and 710, namely the first dimension 700 and the second dimension 710. In FIG. 10 a) the grating information of a one period grating 730 is saved whereas in FIG. 10 b) a binary grating pattern 720 saves the information of a two period grating 740. Still FIG. 10 c) shows the grating pattern information of a three period grating.

Respectively FIG. 11 a) shows the grating pattern 720 information of a two dimensional one period grating 760 whereas FIG. 11 b) shows the grating pattern 720 information of a two dimensional period grating 770.

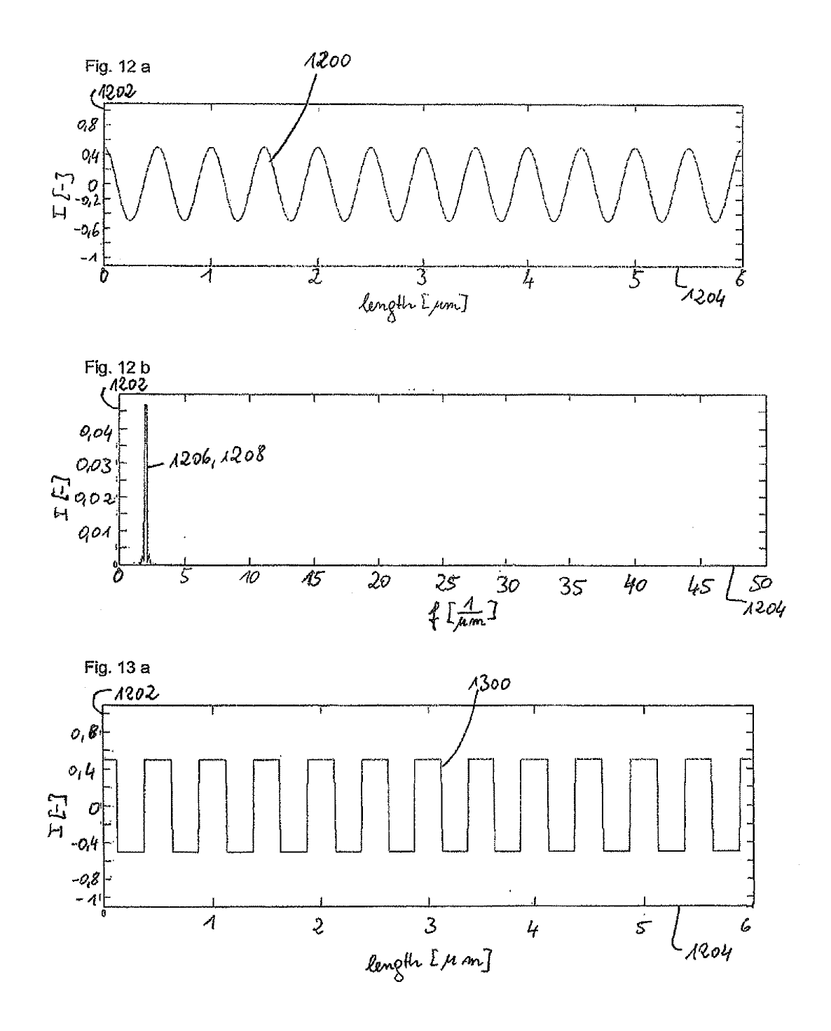

In FIGS. 12 to 14 different wave forms known from the prior art are shown followed by their Fourier transformed Atomic Force spectrum 1206. For example in FIG. 12 a) a scheme of a sinusoidal wave 1200 is shown, where the intensity of the wave 1200 is indicated by the y-axis 1202 and the wavelength is indicated by the x-axis 1204. In FIG. 12 b) the Fourier transformed Atomic Force spectrum (FT-AFS) 1206 of the wave 1200 of FIG. 12 a) is shown. The most characteristic information of this FT-AFS 1206 is that because of the presence of only one frequency in the wave spectrum of the wave 1200 in FIG. 12 a) there is only one Basic Line (BL) 1208 in the FT-AFS 1206 at 2 μm⁻¹. This BL 1208 can be calculated by the formula f=1/λ, wherein f is the frequency indicated on the x-axis 1204 and λ is the wavelength of wave 1200 as indicated on the x-axis 1204 in FIG. 12 a).

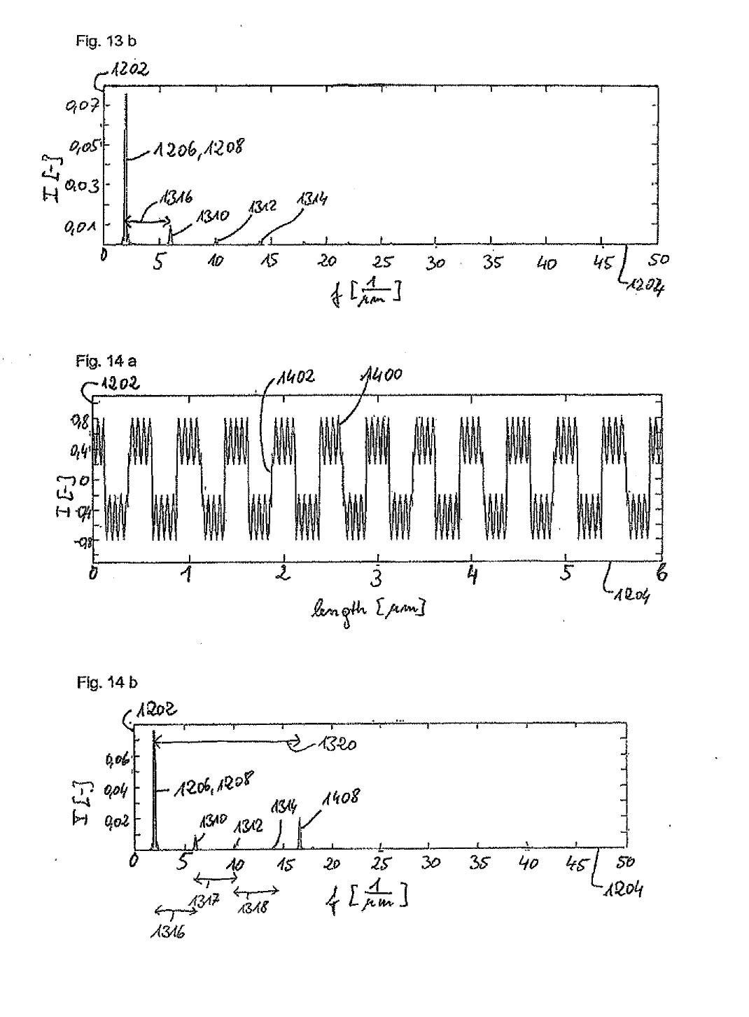

A similar transformation procedure has been made for the rectangular wave 1300 of FIG. 13 a), where also the intensity of the wave 1300 is indicated by the y-axis 1202 and the wavelength is indicated by the x-axis 1204. The FT-AFS 1206 of this wave 1300 is shown in FIG. 13 b). Here in addition to the BL 1308 several overtones 1310, 1312 and 1314 can be found with different amplitudes. The amplitude 1216 for BL 1308 has been indicated as arrow, whereas the amplitudes of the overtones are not marked in FIG. 13a). These overtones 1310, 1312 and 1314 etc. appear at multiple frequencies of the BL 1308. They occur in a distance δ 1316 from the BL 1308 by adding twice the BL value to the preceding value. In this case the frequency value f of BL 1308 is 1f=2 μm⁻¹, so the first overtone 1310 occurs at 3f=6 μm⁻¹, with a distance δ 1316 of 2f to the BL 1308. The next overtone 1312 occurs at 5f=10 μm⁻¹, with a distance δ″ of 2f to the first overtone 1310 and the next overtone 1314 at 7f=14 μm⁻¹ with a distance δ″ of 2f to the second overtone 1312 and so on. These distances δ 1316, δ′ 1317 and δ″ 1318 are measured between the maxima of the peaks of the overtones 1310, 1312 and 1314. So the overtones 1310, 1312 and 1314 have a distance δ 1316, δ′ 1317 and δ″ 1318 that are each greater than the frequency value of the BL 1308 itself. A further characteristic of the FT-AFS 1206 of the rectangular wave 1300 with its overtones 1310, 1312, 1314 etc. is the fact that the amplitudes of the overtones 1310, 1312, 1314 diminish exponentially starting from the BL value of the BL 1308.

In FIG. 14 a) a superposition of a second sinusoidal wave 1400 with a second rectangular wave 1402 is shown. The two waves 1400 and 1402 have different wavelengths which can be read off the x-axis 1204. Wave 1400 has a wavelength of 60 nm and wave 1402 has a wavelength of 500 nm. The pattern of each wave 1400 and 1402 is still visible as the wave 1400 with the shorter wavelength is superposed on the shape of wave 1402. The wavelength and the amplitude of the waves 1400 and 1402 are not changed by this superposition process, so there is no combination effect.

This can also be seen in the FT-AFSpectrum 1206 of the superposed waves 1400 and 1402 shown in FIG. 14 b). Here the BL 1308 of the rectangular wave 1402 with a frequency of f=2 μm⁻¹ together with its overtones 1310, 1312 and 1314 have still the same frequency values as the FT-AFS 1206 of wave 1300 in FIGS. 13 a) and 13 b) with the same wavelength of 500 nm. In addition to this BL 1308 a further BL 1408 can be found at a frequency of f=16.7 μm⁻¹. The distance of the two Baselines BL 1308 and BL 1408 is called the first Baseline distance Δ₁ 1320. This BL distance Δ₁ 1320 is a multiple of the distances δ 1316, δ′ 1317 and δ″ 1318 etc.

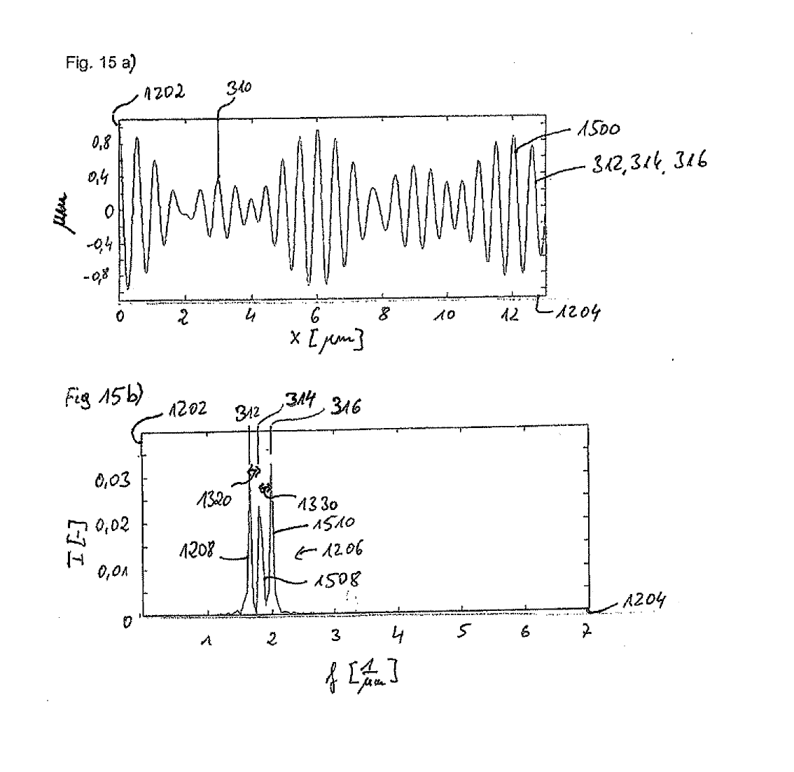

The three dimensional pattern 310 of a three period grating with three waves combined with each other is shown in FIG. 15 a). In contrast to a superposition of several waves as shown in FIG. 14a), the combination of three waves according to the present invention, shown in FIG. 15a) results in a smaller first BL distance Δ₁ 1320 and second BL distance Δ₂ 1330 in the FT-AFSpectrum 1206 shown in FIG. 15b). In the AFS 1206 of the three dimensional patter 310 of FIG. 15 a) three Baselines can be seen, a first BL 1208, a second BL 1508 and a third BL 1510. These Baselines belong to the three combined waves 312, 314 and 316 of the three dimensional pattern 310 in FIG. 15 a). The Baselines distances Δ₁ 1320 and Δ₂ 1330 of the three combined waves 312, 314 and 316 shown as interference wave 1500 in FIG. 15a), is only a fraction of the BL value of each BL 1208 and 1508 itself. This is the result of a real interference of two waves in contrast to a superposition.

List of reference numerals

| | |
|---|---|
| 10 | structure |
| 100 | layered structure |
| 102 | medium/polymer layer |
| 104 | surface/polymer surface |
| 106 | medium waved image |
| 108 | first interface |
| 109 | second interface |
| 110 | transparent substrate |
| 112 | substrate surface |
| 113 | opposite surface |
| 114 | further layer |
| 120 | irradiation beam |
| 130 | reflection beam |
| 140 | transmission beam |
| 150 | reflection spectrum |
| 160 | transmission spectrum |
| 190 | grating period P₁ |
| 192 | length of grating period P1 |
| 202 | resin, resist |
| 204 | resin surface, resist surface |
| 206 | first laser beam |
| 208 | second laser beam |
| 210 | wavelength λ₁ |
| 212 | angle θ₁ |
| 214 | resin or resist waved image |
| 250 | transforming step |
| 260 | coating step |
| 300 | angle θ₂. |
| 302 | third laser beam |
| 304 | fourth laser beam |
| 306 | grating period P₂ |
| 308 | length of P₂ |
| 310 | three dimensional pattern |
| 312 | first wave |
| 314 | second wave |
| 316 | third wave |
| 318 | wavelength of first wave |
| 320 | wavelength of second wave |
| 322 | wavelength of third wave |
| 400 | tilting device |
| 402 | angle γ |
| 500 | grating period P₃ |
| 502 | length of P₃ |
| 510 | wavelength λ₂ |
| 512 | wavelength λ₃ |
| 518 | resulting grating period Pₓ |
| 520 | length of Pₓ |
| 700 | first dimension |
| 710 | second dimension |
| 720 | binary grating pattern |
| 730 | one period grating |
| 740 | two period grating |
| 750 | three period grating |
| 760 | two dimensional one period |
| | grating |
| 770 | two dimensional two period |
| | grating |
| 1200 | sinusoidal wave |
| 1202 | y-axis |
| 1204 | x-axis |
| 1206 | Atomic Force spectrum |
| 1208 | Baseline of sinusoidal wave |
| 1216 | amplitude of BL |
| 1300 | rectangular wave |
| 1308 | Baseline of rectangular wave |
| 1310 | first overtone |
| 1312 | second overtone |
| 1314 | third overtone |
| 1316 | overtone distance δ |
| 1317 | overtone distance δ′ |
| 1318 | overtone distance δ″ |
| 1320 | first BL distance Δ₁ |
| 1330 | Second BL distance Δ₂ |
| 1400 | second sinusoidal wave |
| 1402 | second rectangular wave |
| 1408 | further BL |
| 1500 | interference wave |
| 1508 | second BL |
| 1510 | third BL |

1. A structure, comprising:
a transparent substrate with a surface;
wherein the surface comprises a three dimensional pattern resulting from a combination of at least two surface waves,
the at least two surface waves differ in wavelength by an amount of up to 50% based on a bigger wavelength of the at least two surface waves, and
each of the at least two surface waves has a wavelength of from 200 to 900 nm.

2. The structure according to claim 1, wherein
the transparent substrate is at least partly surrounded by a medium;
the surface locates between the transparent substrate and the medium;
the transparent substrate and the medium differ in refractive index, optionally by at least 0.3, and
the transparent substrate optionally has a refractive index higher than a refractive index of the medium.

3. The structure according to claim 1, wherein the transparent substrate is transparent to solar radiation, and
the three dimensional pattern corresponds to a superposition of the at least two surface waves oriented in the same direction.

4. The structure according to claim 1, wherein the three dimensional pattern has a maximal amplitude in a range of up to 500 nm.

5. The structure according to claim 2, wherein the medium is a solid medium, which optionally comprises a polymer layer.

6. The structure according to claim 2, wherein the medium comprises a thermoplastic polymer.

7. The structure according to claim 1, wherein
the transparent substrate comprises a metal oxide, a metal sulfide or both; or
the transparent substrate consists essentially of at least one material selected from the group consisting of TiO₂, ZnS, Ta₂O₅, ZrO₂, SnN, Si₃N₄, Al₂O₃, Nb₂O₅, HfO₂, and AlN.

8. The structure according to claim 1, wherein the transparent substrate acts as a waveguide and has a thickness in direction perpendicular to the surface ranging from 20 nm to 1500 nm.

9. A process for producing a layered structure, the process comprising:
obtaining a resin comprising a resin surface,
forming a resin waved image on the resin surface,
transforming the resin waved image on a surface of a medium, thereby obtaining a three dimensional pattern resulting from a combination of at least two surface waves,
depositing a transparent substrate on at least a part of the three dimensional pattern, and
altering at least one direction of a first radiation beam or a second radiation beam towards the resin surface, optionally by a variation of an angle θ,
wherein
the resin waved image is formed by applying the first radiation beam from a first direction and the second radiation beam from a second direction on the resin surface,
the first radiation beam is different from the second radiation beam, and
the first radiation beam and the second radiation beam form the angle θ.

10. The process according to claim 9, wherein said altering is carried out by tilting the resin surface relative to a direction of the first radiation beam or the second radiation beam; and
optionally, the first and second radiation beams are each at least one selected from the group consisting of a laser beam and an e-beam.

11. A process for producing the structure according to claim 1, comprising:
obtaining a medium comprising a surface,
transforming at least a portion of the surface into the three dimensional pattern resulting from the combination of the at least two surface waves, and
depositing the transparent substrate on at least a part of the three dimensional pattern.

12. The process according to claim 9, wherein said transforming is one selected from the group consisting of embossing, stamping and printing.

13. A structure obtained from the process according to claim 9.

14. The structure according to claim 1, further comprising a layer, which optionally is a polymer layer, a glass layer, or both.

15. The structure according to claim 1, wherein the structure is a part of a sheet or screen, which is optionally selected from the group consisting of a glass screen and a solar cell.

16. A method for reducing transmission of solar radiation through a plastic film, a plastic sheet, a glass screen, or a solar cell, the method comprising:
including the structure according to claim 1 into a plastic film, a plastic sheet, a glass screen, or a solar cell in need thereof.

17. A method for reducing transmission of solar light, through a transparent element, the method comprising
integrating the structure according to claim 1 into the transparent element.

18. The structure according to claim 6, wherein the thermoplastic polymer is at least one selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, poly vinyl chloride, and polyvinylbutyral.
